(19) United States
(12) Patent Application Publication
(10) Pub. No.: US 2005/0025280 A1
(43) Pub. Date: Feb. 3, 2005

(54) Volumetric 3D x-ray imaging system for baggage inspection including the detection of explosives

(76) Inventor: Robert Schulte, Gaithersburg, MD (US)

Correspondence Address: FULBRIGHT & JAWORSKI L.L.P.;Robert Berliner, Twenty-Ninth Floor, 865 South Figueroa, Los Angeles, CA, 90017-2571, US

(21) Appl. No.: 10/732,612

(22) Filed: Dec. 10, 2003

Related U.S. Application Data
(60) Provisional application No. 60/432,217, filed on Dec. 10, 2002.

(51) Int. Cl. G01N 23/04

(52) U.S. Cl. 378/57

(57) ABSTRACT

A tomographic volumetric x-ray imaging system that uses either multiple x-ray sources in a fixed configuration or a single source that can be shifted to provide a plurality of incident aspect angles. A combination of volumetric x-ray image data and multi-energy image acquisition provides an effective method for high confidence explosives detection within baggage or parcels.

### CROSS REFERENCE TO RELATED APPLICATIONS

This application claims the benefit of Provisional Patent Application No. 60/432,217, filed Dec. 10, 2002.

### FIELD OF THE INVENTION

The fields of art to which the invention pertains include the fields of dynamic tomography and computed tomography, and the field of explosives detection.

### BACKGROUND OF THE INVENTION

Conventional x-ray baggage inspection systems provide 2D, i.e., flat, images of baggage contents with most items overlaying one another producing cluttered, confusing images of baggage contents. Because of the likelihood of overlapping objects making it difficult to interpret the images, there is a need to provide a 3D capability. Conventional computer tomography can provide 3D images, but with its need for a 180 degree scan of the object, it presents a number of practical limitations that are difficult to overcome in providing an inexpensive system that requires only limited training to operate.

In addition to the need for better identification of items in baggage, there is a critical need to be able to detect explosives contained in baggage. Explosives are particularly difficult to detect in baggage, parcels or containers because different materials of low atomic number can produce the same x-ray transmission level when observed on a conventional x-ray screening system.

### BRIEF SUMMARY OF THE INVENTION

The present invention provides a tomographic imaging system that overcomes the drawbacks of conventional computer tomography in a baggage inspection environment, not requiring a full 180-degree scan encompassing the object. In particular, the invention uses either multiple x-ray sources in a fixed configuration or a single source that can be shifted to provide a plurality of incident aspect angles.

The invention uses a Digitome software kernel, developed by Digitome Inc. Digitome is a unique x-ray imaging and inspection system that combines 3D volumetric imaging and conventional 2D radiography for a complete x-ray inspection solution. Digitome technology has been used for film based 3-dimensional x-ray imaging. Its features, provide unique capabilities to view any horizontal or vertical plane, scan through the volume in 0.005″ increments and measure internal features. See Griffith U.S. Pat. No. 5,051,904 (“Computerized Dynamic Tomography System”), U.S. Pat. No. 5,070,454 (“Reference Marker Orientation System For A Radiographic Film-Based Computerized Tomography System”), and U.S. Pat. No. 5,319,550 (“High Resolution Digital Image Registration”), the disclosures of which are incorporated herein by reference.

The present invention provides an effective method for high confidence explosive detection within baggage or parcels by combining volumetric x-ray image data and multi-energy image acquisition. X-ray transmission can distinguish objects of different material types when the effects of thickness are removed from the x-ray transmission image data. The volumetric x-ray technique is capable of determining the thickness of a suspicious object and thus, a direct evaluation of x-ray transmission related to intrinsic material properties is possible, leading to the identification of the material in question.

Features and advantages of the invention will be described hereinafter which form the subject of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is a schematic depiction of the 3D x-ray imaging system of the present invention;

FIG. 2 is a conventional x-ray image of a portion of a handbag containing an explosive simulant, nail file, compact case and house key;

FIG. 3 shows: (a) a view of an explosive simulant at 0.500 inch, (b) a view of a nail file at 1.405 inch, and (c) a view of a compact case at 2.135 inch, each reconstructed by means of a volumetric image obtained with the present invention;

FIG. 4 is a schematic representation of a scanning array module used in the present invention for image acquisition;

FIGS. 5(a) and (b) are conventional 2D x-ray images of purses, each containing three objects;

FIGS. 6(a) and (b) are volumetric views at different locations in each purse of FIGS. 5(a) and (b) showing potential threat objects;

FIGS. 7(a) and (b) show portions of conventional 2D x-ray images of two handbags with three objects in each image;

FIGS. 8(a) and (b) show vertical views through volumetric images of the handbags of FIG. 7;

FIGS. 9(a) and (b) are transmission vs. thickness curves for x-ray exposures, respectively at 70 kV and 120 kV;

FIG. 10 is a schematic depiction of a Delrin marker with four different thicknesses positioned at various locations under the conveyor belt shown in FIG. 1; and

FIGS. 11(a) and (b) are transmission vs. thickness curves showing Delrin curves at 70 kV and 100 kV x-ray energies.

### DETAILED DESCRIPTION OF THE INVENTION

The present invention provides a volumetric x-ray imaging system for baggage screening. In addition, using the volumetric system, the invention provides a method for detecting explosives in the baggage.

Volumetric X-Ray Imaging System for Baggage Screeninq

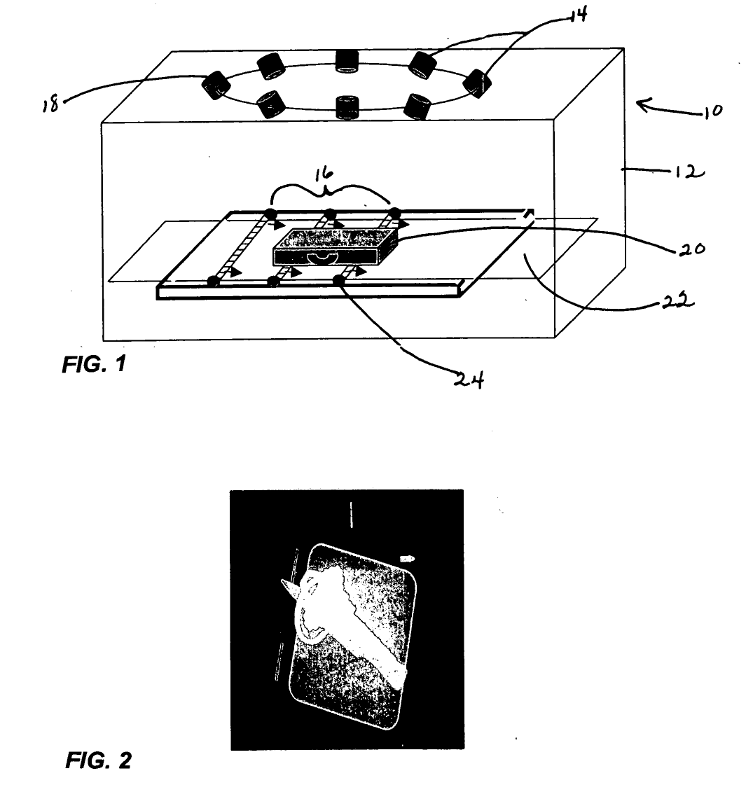

Referring to FIG. 1, In accordance with this invention, there is provided a baggage inspection system 10 comprising a shielded housing 12 containing a bank of multiple x-ray sources 14, each pointing at the inspection area 16 from different perspectives, i.e., at oblique incidences. FIG. 1 shows multiple x-ray sources 14 in a fixed geometric configuration 18. Alternatively, a single x-ray source can be used that is precisely moveable to different positions so as to provide x-ray images from different incident aspect angles.

Baggage 20 is introduced into the system by a conveyor belt 22 that is stopped when the baggage 20 reaches the inspection area 16. Mounted underneath the conveyor belt 22 is a translatable linear detector array (“LDA”) 24. One or more LDAs can be so mounted; three are mounted in this embodiment. (The conveyor belt is depicted partially transparent to show the LDAs 24). The inspection process consists of turning on, i.e., firing, one of the x-ray sources 14, simultaneously sweeping the LDA 24 past the stationary baggage 20 to capture an x-ray image of the complete baggage 20, and storing that image in a computer system. Next, the second x-ray source 14 fires and the LDA is again swept past the baggage 20 to capture a second image from a different x-ray source angle. This sequence is continued for each of the multiple x-ray sources 14 within the system. The baggage 20 has remained stationary during the entire process.

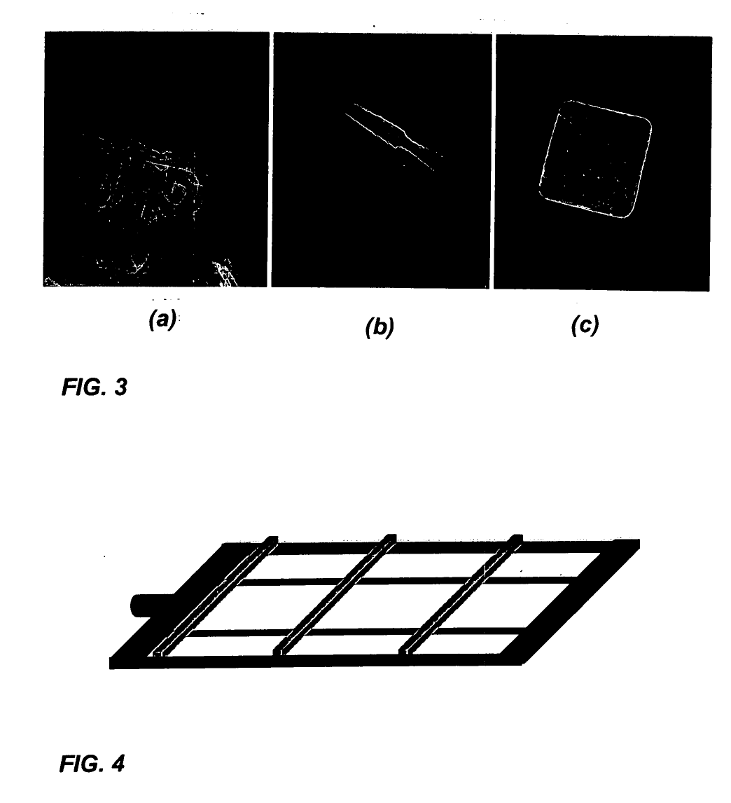

The multiple x-ray images are then processed with the Digitome software (utilizing tomosynthesis techniques) to reconstruct the complete volumetric 3D image for display to the operator. As an example, an x-ray inspection of a handbag was conducted using the Digitome system to demonstrate the capability of distinguishing objects stacked one above the other within a handbag. Referring to FIG. 2, the conventional x-ray shows four objects superimposed in such a way as to obscure the view of certain objects. Referring to FIG. 3, the Digitome horizontal views of the same area of the handbag reveal the objects individually at different levels within the bag (the level of the house key is not shown in the FIG. 3).

Full 3D images of the objects in the bag can be generated from the individual reconstructions at each level within the bag and displayed for interactive viewing at any perspective. This eliminates the possibility of misidentifying a threat object because its x-ray projection onto the 2D plane is not familiar to the operator from that perspective. Explosive detection is accomplished with this concept by using different energy x-ray sources within the 8-source ring, as described further below. The Digitome images shown in FIG. 3 were acquired by taking four images at 70 kV and four images at 140 kV alternately around the source ring and combining these images for the reconstruction at each level of the bag.

The x-ray image set that forms the basis of the volumetric image reconstruction is acquired by a scanning array module (SAM) that contains one or more linear detector arrays (LDA) attached to the carriage of a precision linear motion actuator. The linear motion system has a motion profile that consists of a very short duration, high acceleration phase leading to a constant velocity at which point the detector array attached to the carriage is exposed by the x-ray beam. At the end of the scan a short duration, high deceleration phase completes the motion profile. Each LDA on the SAM captures a section of the overall x-ray image and each image section is concatenated within the image-processing unit to construct the entire planar image for one x-ray exposure of the multiple x-ray image set. FIG. 4 is a schematic diagram of the scanning array module with three LDAs mounted on the carriage. The complete SAM has a cover that is transparent to x-rays (typically a carbon composite) and a lead lined base to absorb the x-ray flux and reduce x-ray scatter that can add noise to the detection system.

To increase the acquisition speed of the module, multiple LDAs are mounted such that each LDA acquires a portion of the total image during the exposure thus limiting the travel of the linear actuator. The image portion acquired by an LDA slightly overlaps the image acquired by the neighboring LDA for the purpose of renormalizing each image section to its adjoining image section. The number of LDAs used depends on the length and speed requirements of the x-ray system. High-speed image acquisition requires multiple LDAs. For example, for a 1 second exposure to capture a 5 foot long image can be accomplished using four LDAs spaced 14.9 inch intervals and scanning over a 15 inch travel at a speed of 1¼ ft/s.

Calibration of the system consists of a geometric calibration and a gain/offset calibration. The geometric calibration establishes the relationship of the x-ray sources to the scanning array module. The gain/offset calibration provides adjustment of the gain and offset for each LDA under each of the multiple x-ray exposures. Since each x-ray source exposes the LDAs to a significantly different x-ray flux, a dynamic gain/offset adjustment is made so that the x-ray response of each LDA provides the best overall image contrast. The combined calibration is accomplished with a single set of exposures with the x-ray system empty and a second set of exposures taken with a calibration post inserted to provide the geometric alignment information. The images captured with each of the multiple x-ray sources provide the gain/offset adjustment factor for subsequent scanning operations.

The dynamic gain adjustment also accommodates the wide dynamic range of the exposures at the various energies of the multi-energy approach used in the volumetric x-ray imaging system. Over-exposure or under-exposure of an LDA results in poorer image contrast for baggage screening. The LDA gain in this system is adjusted to match the LDA response to each different x-ray source energy so that near-optimal image contrast is achieved.

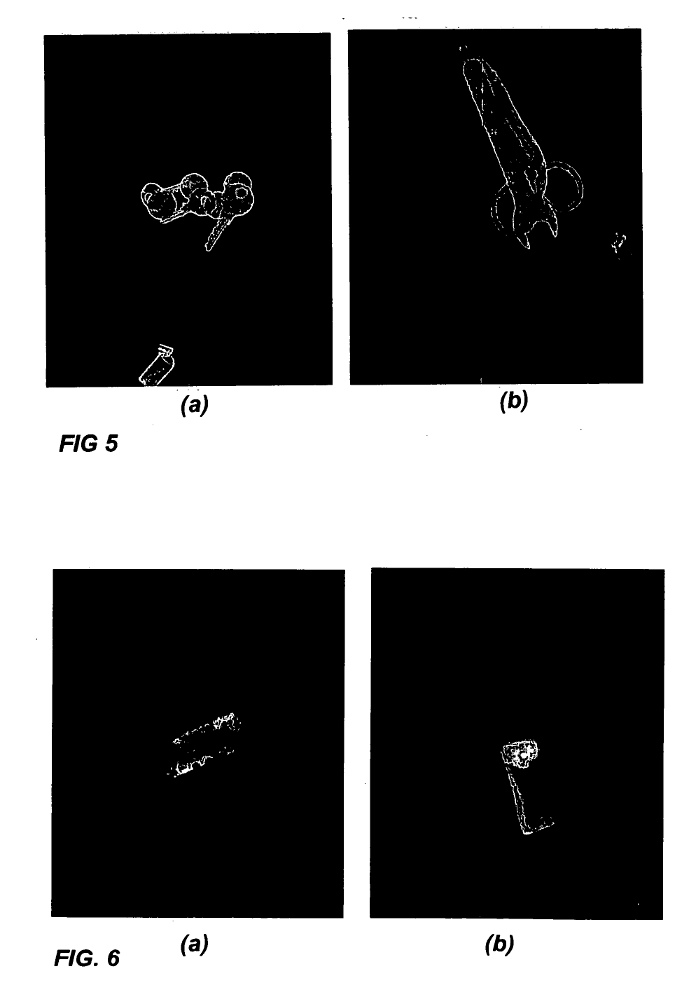

The volumetric x-ray baggage screening unit collects the multiple x-ray image set appropriate for volumetric reconstruction using the Digitome software. FIG. 5 shows examples of conventional 2D x-ray images of a small purse containing a few common items. The arrangement of the items is such that the contents of the each purse are not easily identified. However, reconstruction of the volumetric images for each purse reveals all the items. FIG. 6 shows horizontal views selected so that one of the obscured items is clearly visible. The complete volumetric image, of course, contains views of the remaining objects in the purse.

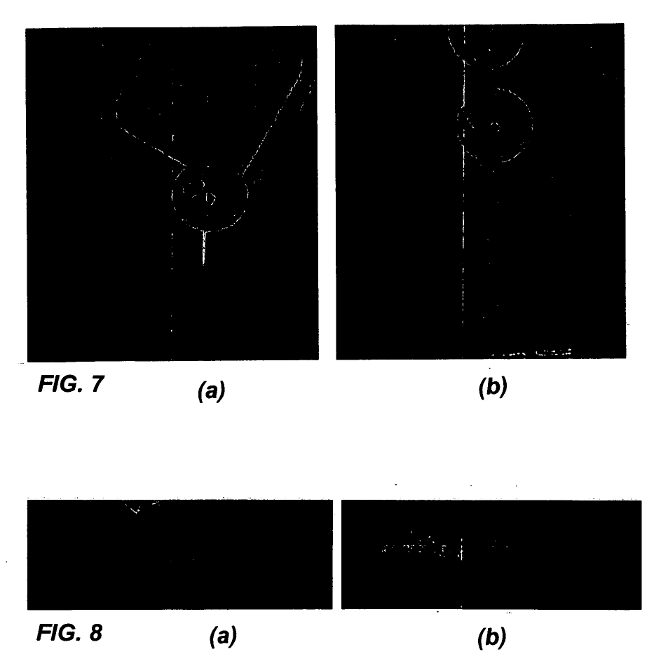

Any view through the baggage can be displayed with full volumetric imaging. For example, FIG. 7 shows a portion of conventional 2D x-ray images of two handbags with just three objects in each image. The orientation of the objects is such that not all the items are easily recognizable. The volumetric image, however, can be viewed along any section through the image providing views that allow the operator to see objects from different perspectives. FIG. 8 shows vertical views through the volumetric image that provide a cross-sectional view of potential threat objects (The images of FIG. 8 correspond to the images shown in FIG. 7).

The volumetric x-ray imaging system can (1) produce static views through any plane of the full volumetric image (as shown in FIGS. 6 and 8), (2) render the entire contents of the bag in 3D isometric views or (3) create real-time sequential image scanning of the volumetric image that provides dynamic viewing through selected regions of the baggage.

Features and Advantages of Volumetric X-ray Imaging System for Baggage Screening:
Full volumetric x-ray imaging of the baggage contents are achieved through multiple x-ray images acquired in an automated sequence.
The fixed geometry of the x-ray sources, LDA and baggage produces multiple images for volumetric reconstruction without the need for fiducial markers to establish the geometric configuration.
The LDA sweep is controlled by a precision linear motion actuator that is timed with each x-ray exposure to produce consistent x-ray images.
Multiple LDAs can be used to shorten the x-ray exposure time by capturing a portion of the image and concatenating the image portions within the computer to provide a complete x-ray image of the baggage.
Multiple LDAs can be used to capture dual energy x-ray exposure to distinguish different densities of the baggage contents for specific threat detection, such as from explosives.
The volumetric images provide views of the baggage contents with reduced interference of overlying items in the baggage. Any view or section of the complete volumetric image can be reconstructed to view a particular region of the baggage.
   Explosives Detection Method

The combination of volumetric x-ray image data and multi-energy image acquisition provides an effective method for high confidence explosive detection within baggage or parcels. X-ray transmission can distinguish objects of different material types when the effects of thickness are removed from the x-ray transmission image data. The volumetric x-ray technique is capable of determining the thickness of a suspicious object and thus, a direct evaluation of x-ray transmission related to intrinsic material properties is enabled, leading to the identification of the material in question.

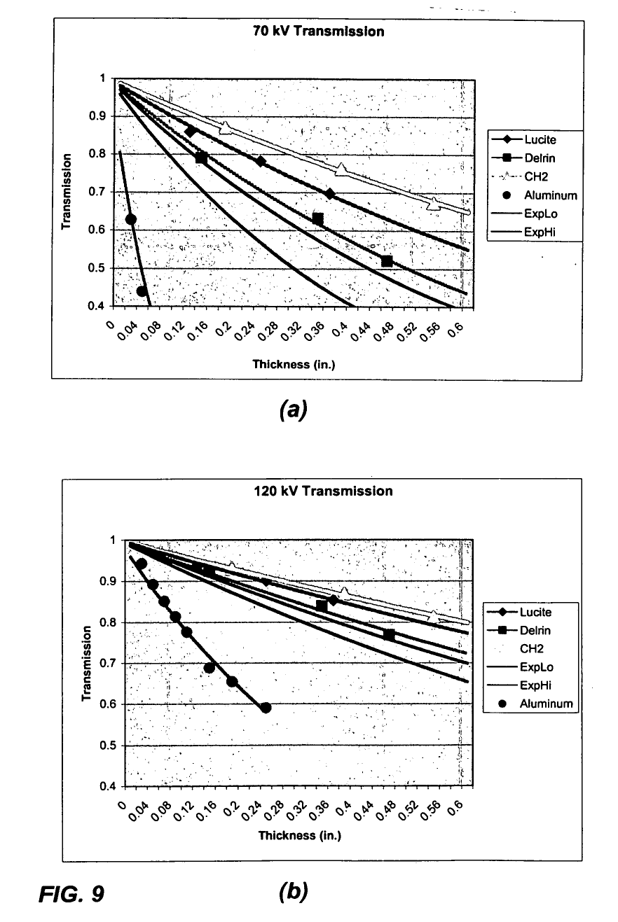

A set of curves can be generated for each x-ray energy and background level, so that, when the measured transmission and thickness are determined and the comparison with the appropriate chart is made, the material type is specified. FIGS. 9(a) and (b) show two sets of curves, respectively at 70 kV transmission and 120 kV transmission, as measured for some common materials and an estimate of the region (high and low limits) where explosives are most likely to occur. These two sets of curves illustrate the method for identifying the material type. The transmitted x-ray intensity is exponentially related to the density of the material as well as its attenuation coefficient and its thickness. The thickness of the material can be determined by a thickness measurement provided by the volumetric image. The attenuation coefficient for most explosives is relatively constant, i.e., it does not vary significantly with material composition. Therefore, once the thickness is determined, the net transmission vs. thickness curve specifies. the density of the material. Explosives generally have densities in the range of 1.45 to 1.8, therefore for a value in this range, the material is most likely to be an explosive. Multiple independent measurements from each of the multi-energy x-ray exposures provide improved statistics for the identification of the material

The range of values that encompass most explosive materials falls within the ExploLo and ExploHi lines shown on these charts. Therefore, specific combinations of x-ray transmission and thickness values will designate an object as a potential explosive. Using multi-energy radiation to acquire the set of x-ray images needed for the volumetric image reconstruction increases the confidence of the statistical decision process in making the correct identification. Therefore, the process can significantly reduce the false alarm rate for the volumetric x-ray imaging system.

The transmission vs. thickness curves are developed through the exponential x-ray attenuation properties of materials given by:
I=Iₒ exp(−μρt)
where I=transmitted intensity
Iₒ=incident intensity
μ=attenuation coefficient
ρ=material density
t=material thickness
   and the attenuation coefficient for compound materials is given by:
   μ=1/ρ Σ μᵢρᵢ
   But for the energy range of 70 kV≦E≦140 kV, the attenuation coefficients for the elements (C, N, 0) in most common plastics and explosives are effectively the same, i.e.,
   μ_{C}≈μ_{N}≈μ_{O}
   therefore: μ_{T}≈1/ρ[μ_{H}ρ+μ_{C,N,O} Σ ρᵢ]
   But, for explosives, we have that:
   μ_{H}ρ<<μ_{C,N,O} Σ ρᵢ Generally: μ_{H}ρ≦6% of total
   Then: μ_{T}≈1/ρ μ_{C,N,O} Σ ρᵢ where: Σ ρᵢ≈ρ
   Therefore: μ_{T}≈μ_{C,N,O}

The attenuation coefficient for an explosive material is effectively equal to the attenuation coefficient for oxygen. As an example, the attenuation coefficient for C4 explosive is 0.165 cm²/g and the attenuation coefficient for oxygen is 0.162 cm²/g.

The attenuation coefficients for C, N or 0 vary only slightly over the energy range of 70-140 kV implying that the shape (slope) of the transmission vs. thickness curves will depend on the density of the material once the effects of interfering material attenuation are taken into account. Explosives generally have densities in the range of 1.45-1.8 g/cm3 and will be separated from most common materials when the thickness of the suspicious material is determined through the volumetric image thickness measurement.

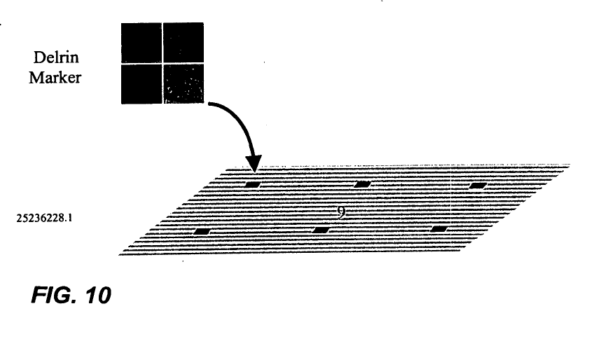

Delrin is the trade name of an acetyl resin that has a density of 1.4 g/cm³ which is greater that most common materials but less that most explosives. The volumetric x-ray imaging system uses a Delrin marker placed at various locations just below the conveyor belt and above the LDAs in the system so that these Delrin markers are captured in each x-ray image acquired by the screening process. Each Delrin marker is machined to 4 different thicknesses and their positions are preset, the transmission vs. thickness curve for Delrin is immediately calculated for each baggage condition and can be used as a discriminator for distinguishing common materials from explosives. FIG. 10 shows one possible layout for the Delrin markers under the conveyor belt.

Once the transmission factor and thickness of the designated material is determined from the volumetric images, a direct comparison is made to the Delrin curve for that portion of the bag. If the result lies below the Delrin curve, the material is likely an explosive; if the result lies on or above the curve, the material is not likely to be an explosive.

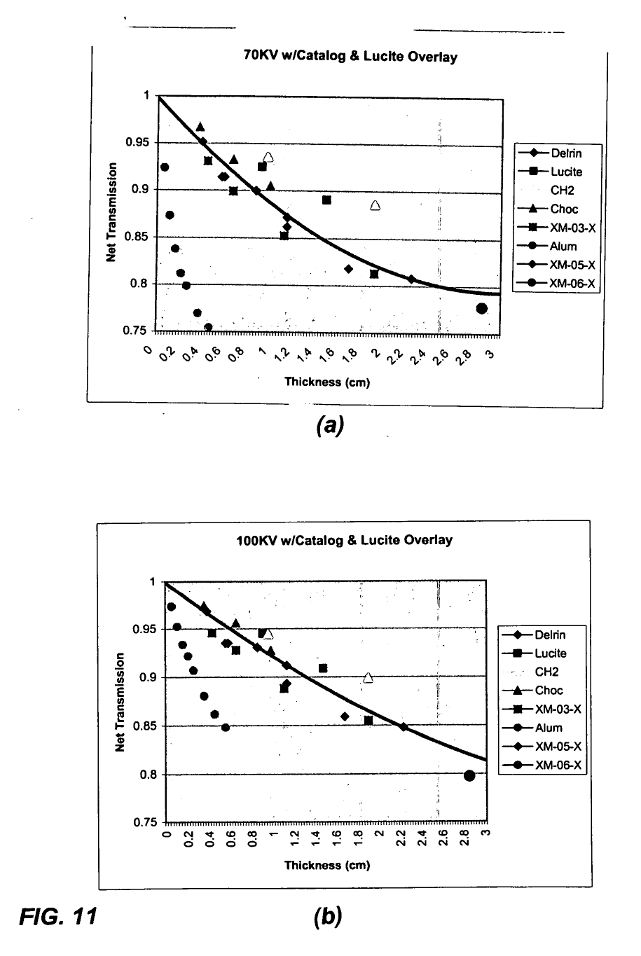

This transmission vs. thickness data are available for each of the multi-energy exposures taken with the volumetric x-ray imaging system, therefore, whenever a material is flagged as a potential explosive, the other images are also analyzed to improve the statistics for making a high confidence classification of explosive vs. non-explosive material. FIGS. 11(a) and 11(b) show the transmission vs. thickness curves for two different energies with the Delrin curve for four different thicknesses shown as the solid line on the graph. The explosive simulants for dynamite (XM-06), C-4 (XM-03) and Detasheet (XM-05), which have comparable densities to their actual explosive counterparts, lie below the Delrin curve in each case. At the higher x-ray exposure energies the trend for these curves is to be more closely spaced, so that better discrimination is achieved for lower energy x-ray energies. The volumetric x-ray imaging system uses its multi-energy exposures to take advantage of the improved discrimination at lower energies by setting most of the x-ray sources to expose in the range of 70 kV to 95 kV; typically two of the x-ray tubes will be set in the 100-140 kV energy range. The x-ray tubes in the low energy range will typically be set at 5 kV intervals to span the entire range of the low x-ray energies.

The complete process for explosive detection using the DIGITOME® technology is as follows:
Acquire multiple x-ray images from different viewpoints about the baggage or parcel using different energy x-rays at several or at each of the different viewpoints.
Determine whether a suspicious object is present in any of the images by measuring the radioscopic transmission factor for the object. Compare this to a step wedge reference standard (Delrin marker) to establish a range of transmission factors that are consistent with a potential explosive material. Background normalization or correction is required to obtain a net transmission value.
Reconstruct a volumetric image of the region containing the suspicious object. Determine the thickness of the object. Depending on the orientation of the object within the baggage, this may be accomplished by either a single cross sectional view through the object or may require the use of an edge location routine to provide a thickness determination along the edges of the object.
Compare the transmission factor at the designated thickness to the established reference curves for various materials. The appropriate set of reference curves for comparison will be specified by the background normalization. This comparison should be made at each of the multiple energies for which images were acquired.
A statistical decision process is used to determine whether the suspicious object meets the “alarm threshold” criteria that would indicate the presence of a likely explosive.

Features and Advantages of Explosives Detection Method:
Full volumetric imaging combined with multi-energy x-ray exposure can distinguish one material from another to identify explosive materials.
The volumetric x-ray imaging system produces full volumetric images of the entire bag during baggage screening.
Volumetric imaging provides views of bag contents by reducing image obstruction of items positioned above and/or beneath the objects.
The volumetric x-ray imaging system can produce static views through any plane of the full volumetric image or render the entire contents of the bag in 3D isometric views or create real-time sequential image scanning of the volumetric image that provides dynamic viewing through selected regions of the baggage.
The thickness of objects in the baggage can be measured though the Digitome® software measurement toolkit in conjunction with edge detection methods.
Measuring the thickness of suspicious objects through volumetric imaging along with their x-ray transmission properties through multi-energy exposure determines a pair of coordinates that, when compared to reference curves obtained from appropriately positioned Delrin markers, specifies whether the material is a potential explosive.
Depending on the orientation of the suspicious object within the bag/ parcel, a direct thickness determination can be made using a cross-sectional view through the volumetric image or using edge detection methods to extract the thickness along the edge of the object.
X-ray transmission factors for different energies can be specified for each thickness of different materials and background conditions so that direct comparison of the measured values can be made to indicate the presence of an explosive material.
Statistical decision methods applied to the multi-energy measurements increase the confidence for specifying the correct material type, leading to reduced false alarm rates.
The background compensation approach allows determination of the material type even if other materials completely cover the suspicious object although the confidence level for specifying an explosive is slightly reduced.

1. A baggage inspection system, comprising:
a support for baggage to be inspected;
at least one source of baggage penetrating radiation locatable at multiple positions with respect to the baggage support;
means for receiving said baggage penetrating radiation after it passes through baggage to obtain therefrom multiple images of the contents of said baggage from different angles of incidence; and
means for reconstructing said multiple images to provide volumetric 3D images of the content of the baggage.

2. The system of claim 1 in which said at least one source of baggage penetrating radiation comprises a bank of multiple sources, each directed to baggage on the support from a different angle of incidence.

3. The system of claim 1 in which each angle of incidence is oblique to the baggage.

4. The system of claim 1 in which said at least one source of baggage penetrating radiation comprises a source that is movable to different positions whereby to provide said multiple images.

5. The system of claim 4 in which each angle of incidence is oblique to the baggage.

6. The system of claim 1 in which said multiple positions are predetermined.

7. The system of claim 1 in which said baggage penetrating radiation is x-ray radiation.

8. The system of claim 1 in which said support comprises a conveyor belt.

9. The system of claim 1 in which said means for receiving said baggage penetrating radiation is at least one translatable linear detector array.

10. The system of claim 9 including a carriage for translating said linear detector array.

11. The system of claim 9 in which said support comprises a conveyor belt overlying said at least one translatable linear detector array.

12. The system of claim 1 comprising means for sequentially actuating said at least one source of radiation at said multiple predetermined positions.

13. The system of claim 1 in which said means for reconstructing said multiple images comprises a method of tomosynthesis.

14. The system of claim 1 comprising at least one marker, having a density less than 1.45 g/cm³, located between said radiation source and said radiation receiving means.

15. The system of claim 14 in which said at least one marker has a plurality of thicknesses.

16. The system of claim 15 in which each marker is formed with a plurality of thicknesses.

17. The system of claim 14 in which there are a plurality of said markers.

18. The system of claim 14 in which said at least one marker is formed of an acetyl resin.

19. A baggage inspection system, comprising:
a conveyor belt for baggage to be inspected;
a bank of multiple sources of x-ray radiation locatable at multiple predetermined positions with respect to the baggage support, each directed to baggage on the support from a different angle of incidence oblique to the baggage and sequentially actuated;
a plurality of translatable carriages below said conveyor belt, each carrying a linear detector array for receiving said x-ray radiation after it passes through baggage to obtain therefrom multiple images of the contents of said baggage from different angles of incidence; and
means for reconstructing said multiple images by tomosynthesis to provide volumetric 3D images of the content of the baggage.

20. The system of claim 19 comprising a plurality of acetyl resin markers, each having a density less than 1.45 g/cm³, among which is a plurality of thicknesses, located between said radiation source and said radiation receiving means.

21. A method for inspecting baggage, comprising:
passing baggage penetrating radiation through baggage to be inspected from multiple locations;
receiving said baggage penetrating radiation after it passes through baggage to obtain therefrom multiple images of the contents of said baggage from different angles of incidence; and
reconstructing said multiple images to provide volumetric 3D images of the content of the baggage.

22. The method of claim 21 in which there is a source of baggage penetrating radiation at each of said multiple locations, each directed to the baggage from a different angle of incidence.

23. The method of claim 22 in which each angle of incidence is oblique to the baggage.

24. The method of claim 21 in which said radiation is passed through said baggage by moving a source thereof to each of said locations.

25. The method of claim 24 in which each angle of incidence is oblique to the baggage.

26. The method of claim 21 in which said multiple locations are predetermined.

27. The method of claim 21 in which said baggage penetrating radiation is x-ray radiation.

28. The method of claim 21 in which said baggage is carried on a conveyor belt.

29. The method of claim 21 in which said baggage penetrating radiation is received by at least one translatable linear detector array.

30. The method of claim 21 in which said baggage penetrating radiation is sequentially actuated.

31. The method of claim 21 in which said multiple images are reconstructed by tomosynthesis.

32. The method of claim 21 for determining the presence of an explosive substance in said baggage, comprising:
determining the density of content of the baggage; and
characterize said content as explosive material when the density of the content is determined to be at least 1.45 g/cm³.

33. The method of claim 32 in which said content of the baggage is characterized as explosive material when the density of said content is determined to be in the range of 1.45 g/cm³ to 1.80 g/cm³.

34. The method of claim 32 in which the density of said content is determined by:
locating at least one marker, formed of a material having a density less than 1.45 g/cm³, and having at least two thicknesses, in the path of said radiation whereby to capture an image thereof in each of said multiple images, said at least one marker having a plurality of thicknesses;
calculating a transmission vs. thickness discriminator curve for said material;
determining transmission and thickness of content of said baggage; and
comparing the baggage content transmission and thickness to said discriminator curve whereby to determine the density of said content.

35. The method of claim 34 in which each marker has a plurality of thicknesses.

36. The method of claim 34 in which there are a plurality of said markers.

37. The system of claim 34 in which said at least one marker is formed of an acetyl resin.

38. A method for inspecting baggage, comprising:
passing x-ray radiation through baggage to be inspected from x-ray sources at multiple predetermined locations each directed to the baggage from a different angle of incidence oblique to the baggage and sequentially actuated;
receiving said baggage penetrating radiation by at least one translatable linear detector array after the radiation passes through the baggage to obtain therefrom multiple images of the contents of said baggage from different angles of incidence; and
reconstructing said multiple images by tomosynthesis to provide volumetric 3D images of the content of the baggage.

39. The method of claim 38 for determining the presence of an explosive substance in said baggage, comprising:
determining the density of content of the baggage; and
characterize said content as explosive material when the density of the content is determined to be at least 1.45 g/cm³.

40. The method of claim 39 in which said content of the baggage is characterized as explosive material when the density of said content is determined to be in the range of 1.45 g/cm³ to 1.80 g/cm³.

41. The method of claim 39 in which the density of said content is determined by:
locating at least one marker, formed of a material having a density less than 1.45 g/cm³, and having at least two thicknesses, in the path of said radiation whereby to capture an image thereof in each of said multiple images, said at least one marker having a plurality of thicknesses;
calculating a transmission vs. thickness discriminator curve for said material;
determining transmission and thickness of content of said baggage; and
comparing the baggage content transmission and thickness to said discriminator curve whereby to determine the density of said content.

42. The method of claim 41 in which each marker has a plurality of thicknesses.

43. The method of claim 41 in which there are a plurality of said markers.

44. The system of claim 41 in which said at least one marker is formed of an acetyl resin.
